(19) United States
(12) Patent Application Publication
(10) Pub. No.: US 2026/0011481 A1
(43) Pub. Date: Jan. 8, 2026

(54) POWER MODULE

(71) Applicant: Monolithic Power Systems, Inc., Kirkland, WA (US)

(72) Inventors: Hao-Shiang Huang, New Taipei City (TW); Kuan-Hung Wu, New Taipei City (TW); Chia-Hsi Chang, New Taipei City (TW)

(21) Appl. No.: 18/763,443

(22) Filed: Jul. 3, 2024

(51) Int. Cl. H01F 27/28; H01F 27/08; H01F 27/24

(52) U.S. Cl. CPC H01F 27/2804; H01F 27/08; H01F 27/24; H01F 2027/2809; H01F 2027/2819

(57) ABSTRACT

A power module for a switching circuit is provided. The power module includes a substrate, power devices, a magnetic component, a metallic coating, and a heat spreader. The magnetic component includes a magnetic core, a primary winding, and a secondary winding. The metallic coating is covered on the substrate. The metallic coating includes a first portion and a second portion, the first portion is covered on the side edge surface of the substrate, the second portion is covered on a portion of the top surface of the substrate, and the second portion is connected to the first portion. The heat spreader is disposed on top of the plurality of power devices. The heat spreader has at least one supporting terminal connected to the top surface of the substrate, and one of the at least one supporting terminals is connected to the metallic coating.

### TECHNICAL FIELD

The present disclosure relates generally to electronic circuits, and more particularly but not exclusively to power modules.

### BACKGROUND OF THE INVENTION

Power modules are employed to provide one or more voltages to various electronic devices. A power module may integrate a magnetic component, a plurality of power integrated circuits (ICs), a plurality of driver ICs, a plurality of passive devices, etc. Furthermore, to improve integration, the size of the power module needs to be small. In high power applications, large currents also bring challenges to thermal performance of the power module. Therefore, it is desirable to provide a cost-effective power module with high-power density, high-efficiency, excellent heat dissipation capability in space-constrained environments.

### SUMMARY OF THE INVENTION

According to an embodiment of the present disclosure, a power module is provided. The power module includes a substrate, power devices, a magnetic component, a metallic coating, and a heat spreader. The substrate has a top surface, a bottom surface, and a side edge surface. The side edge surface extends between the top surface and the bottom surface. The power devices are disposed on the top surface of the substrate. The magnetic component disposed on the substrate. The magnetic component includes a magnetic core, a primary winding, and a secondary winding, and the primary winding and the secondary winding are wound on the magnetic core. The metallic coating is covered on the substrate. The metallic coating includes a first portion and a second portion, the first portion is covered on the side edge surface of the substrate, the second portion is covered on a portion of the top surface of the substrate, and the second portion is connected to the first portion. The heat spreader is disposed on top of the plurality of power devices. The heat spreader has at least one supporting terminal connected to the top surface of the substrate, and one of the at least one supporting terminals is connected to the metallic coating.

According to another embodiment of the present disclosure, a power module is provided. The power module includes a substrate, power devices, and a magnetic component. The substrate has a top surface, a bottom surface, and a side edge surface. The side edge surface extends between the top surface and the bottom surface. The power devices are disposed on the top surface of the substrate. The magnetic component disposed on the substrate. The magnetic component includes a magnetic core, a primary winding, and a secondary winding, and the primary winding and the secondary winding are wound on the magnetic core. The primary winding is formed on a first set of PCB layers, the secondary winding is formed on a second set of PCB layers, and the first set of PCB layers and the second set of PCB layers are stacked vertically to form a winding stack. The winding stack includes first vias and second vias, each of the first vias is configured to electrically connect traces of the primary winding on different PCB layers, and each of the second vias is configured to electrically connect traces of the secondary winding on different PCB layers. For each of the first set of PCB layers, each of the first vias has a first through-hole and a first pad surrounded the first through-hole, and for each of the second set of PCB layers, each of the second vias has a second through-hole and a second pad surrounded the second through-hole.

According to yet another embodiment of the present disclosure, a power module is provided. The power module includes a substrate, power devices, a magnetic component, a metallic coating, and a heat spreader. The substrate has a top surface, a bottom surface, and a side edge surface. The side edge surface extends between the top surface and the bottom surface. The power devices are disposed on the top surface of the substrate. The magnetic component disposed on the substrate. The magnetic component includes a magnetic core, a primary winding, and a secondary winding, and the primary winding and the secondary winding are wound on the magnetic core. The metallic coating is covered on the side edge surface of the substrate. The heat spreader is connected to the metallic coating.

### BRIEF DESCRIPTION OF THE DRAWINGS

The present disclosure can be further understood with reference to following detailed description and appended drawings, wherein like elements are provided with like reference numerals. These drawings are only for illustration purpose, thus may only show part of the devices and are not necessarily drawn to scale.

FIG. 1A is a schematic diagram of a converter circuit 100A in accordance with an embodiment of the present disclosure.

FIG. 1B is a schematic diagram of a converter circuit 100B in accordance with another embodiment of the present disclosure.

FIG. 2A is an explosive view of a power module 200 in accordance with an embodiment of the present invention.

FIG. 2B is a side view of the power module 200 as shown in FIG. 2A in accordance with an embodiment of the present disclosure.

FIG. 2C is a top view of the power module 200 as shown in FIG. 2A in accordance with an embodiment of the present invention.

FIG. 2D is a top view of the power module 200 as shown in FIG. 2A with the heat spreader 280 in accordance with an embodiment of the present invention.

FIG. 3A is a top view of a power module 300A in accordance with another embodiment of the present invention.

FIG. 3B is a top view of a power module 300B in accordance with yet another embodiment of the present invention.

FIG. 3C is a top view of a power module 300C in accordance with yet another embodiment of the present invention.

FIG. 4A is a side view of the power module 200 in accordance with another embodiment of the present disclosure.

FIG. 4B is a bottom view of the power module 200 in accordance with another embodiment of the present disclosure.

FIG. 5A is a top view of a power module 500 in accordance with another embodiment of the present invention.

FIG. 5B is a top view of the power module 500 as shown in FIG. 5A with a heat spreader 520 in accordance with another embodiment of the present invention.

FIG. 5C is a side view of the power module 500 with the heat spreader 520 in accordance with another embodiment of the present disclosure.

FIG. 6 is an enlarged view of a portion of a power module 600 in accordance with another embodiment of the present disclosure.

FIG. 7 is a schematic view of heat transmission paths of a power module 700 in accordance with an embodiment of the present disclosure.

FIG. 8A is a schematic diagram of a magnetic core 800 of the magnetic component 240 as shown in FIGS. 2A-2D in accordance with an embodiment of the present disclosure.

FIG. 8B is a cross-sectional view of the magnetic component 240 as shown in FIGS. 2A-2D in accordance with an embodiment of the present disclosure.

FIGS. 9A-9B are plan views of the primary windings 900A and 900B formed on the PCB layers La and Lb in accordance with an embodiment of the present disclosure.

FIGS. 10A-10B are plan views of the primary windings 1000A and 1000B formed on the PCB layers La and Lb in accordance with another embodiment of the present disclosure.

FIGS. 11A-11B are plan views of the primary windings 1100A and 1100B formed on the PCB layers La and Lb in accordance with yet another embodiment of the present disclosure.

FIG. 12 is a schematic cross-sectional view of a winding stack formed in the substrate 210 in accordance with an embodiment of the present disclosure.

FIG. 13A is an explosive view of a power module 1300 in accordance with an embodiment of the present invention.

FIG. 13B is a bottom view of the power module 1300 in accordance with an embodiment of the present disclosure.

The use of the same reference label in different drawings indicates the same or like components.

### DETAILED DESCRIPTION

Various embodiments of the present disclosure will now be described. In the following description, some specific details, such as example circuits and example values for these circuit components, are included to provide a thorough understanding of embodiments. One skilled in the relevant art will recognize, however, that the present disclosure can be practiced without one or more specific details, or with other methods, components, materials, etc. In other instances, well-known structures, materials, processes or operations are not shown or described in detail to avoid obscuring aspects of the present disclosure.

Throughout the specification and claims, the terms “left”, “right”, “in”, “out”, “front”, “back”, “up”, “down”, “top”, “atop”, “bottom”, “on”, “over”, “under”, “above”, “below”, “vertical” and the like, if any, are used for descriptive purposes and not necessarily for describing permanent relative positions. It is to be understood that the terms so used are interchangeable under appropriate circumstances such that embodiments of the technology described herein are, for example, capable of operation in other orientations than those illustrated or otherwise described herein. The phrases “in one embodiment”, “in some embodiments”, “in one implementation”, and “in some implementations” as used include both combinations and sub-combinations of various features described herein as well as variations and modifications thereof. These phrases used herein do not necessarily refer to the same embodiment, although they may. Those skilled in the art should understand that the meanings of the terms identified above do not necessarily limit the terms, but merely provide illustrative examples for the terms. It is noted that when an element is “connected to” or “coupled to” the other element, it means that the element is directly connected to or coupled to the other element, or that the element is indirectly connected to or coupled to the other element via another element. Particular features, structures or characteristics may be included in an integrated circuit, an electronic circuit, a combinational logic circuit, or other suitable components that provide the described functionality. In addition, it is appreciated that the figures provided herewith are for explanation purposes to persons ordinarily skilled in the art and that the drawings are not necessarily drawn to scale.

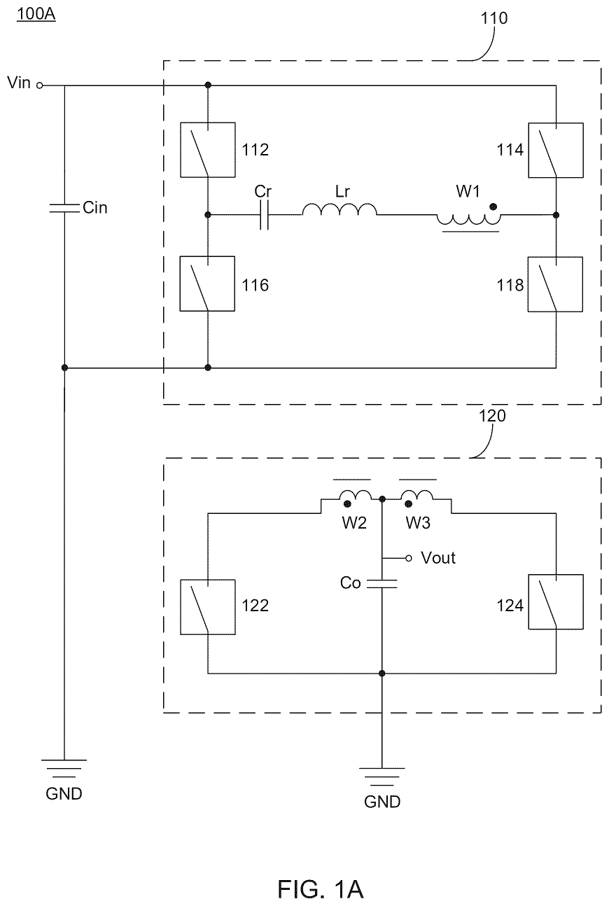

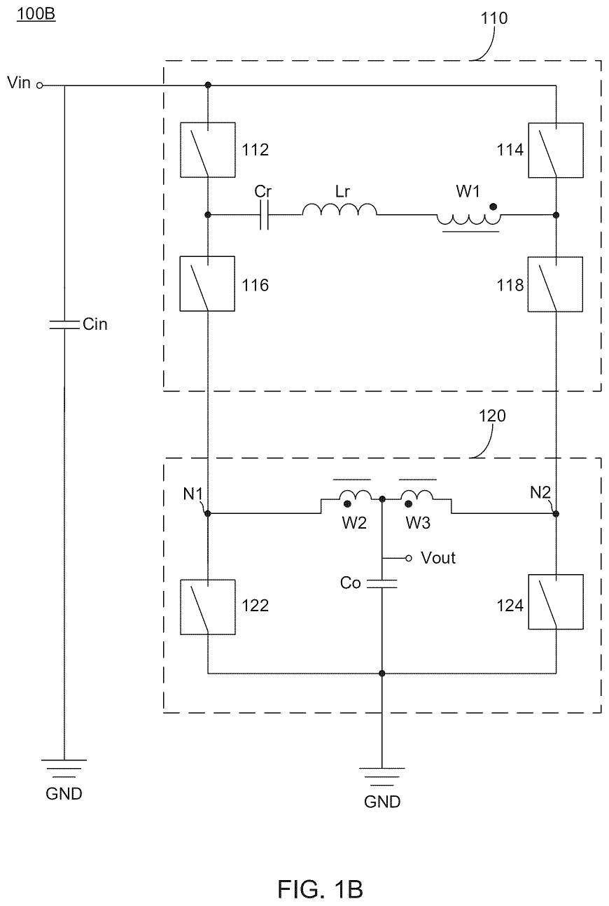

FIG. 1A is a schematic diagram of a converter circuit 100A in accordance with an embodiment of the present disclosure. The converter circuit 100A includes a primary side circuit 110 and a secondary side circuit 120. The converter circuit 100A is configured to receive an input voltage Vin through the primary side circuit 110, and is configured to provide an output voltage Vout through the secondary side circuit 120. The primary side circuit 110 includes power switches 112, 114, 116, and 118, a resonant capacitor Cr, a resonant inductor Lr, and a primary winding W1. The secondary side circuit 120 includes switching units 122 and 124 and secondary windings W2 and W3.

In one embodiment, the converter circuit 100A is an LLC converter that includes power switches, a resonant tank, a transformer, and a rectifier. In the embodiment of FIG. 1A, the resonant tank includes the resonant capacitor Cr, the resonant inductor Lr, and the magnetizing inductor of the primary winding W1, the transformer includes the primary winding W1, the secondary winding W2, and a magnetic core, and the secondary side circuit 120 forms the rectifier. First, the power switches 112, 114, 116, and 118 are configured to convert the DC input voltage Vin into a square wave. The square wave then enters the resonant tank. The resonant tank eliminates the square wave's harmonics and outputs a resonant sinusoidal current to the transformer. The current is scaled up by the transformer, and then the secondary side circuit 120 outputs the rectified DC output voltage Vout.

In the embodiment of FIG. 1A, the primary side circuit 110 includes a full-bridge circuit that is formed by the power switches 112, 114, 116, and 118. In alternative embodiments, the primary side circuit 110 may include a half-bridge circuit.

In the embodiment of FIG. 1A, the resonant inductor Lr is a leakage inductance of the primary winding W1. The windings W2 and W3 are coupled in series. A common connection node of the windings W2 and W3 is coupled to the output voltage Vout. In some embodiments, the secondary side circuit 120 further includes an output capacitor Co that is coupled between the output voltage Vout and the ground voltage GND and is configured to filter the output voltage Vout.

In the example of FIG. 1A, the transformer has one primary winding W1 on a primary side of the transformer and two secondary windings W2 and W3 on a secondary side of the transformer. Persons having ordinary skills in the art should understand that in other embodiments, the numbers of the primary winding and the secondary winding may be adjusted according to actual applications of the power module.

In some embodiments, each of the power switches 112, 114, 116, 118, 122, and 124 may include at least a power device, e.g., a metal-oxide-semiconductor field-effect transistor (MOSFET). In some implementations, each of the power switches may include more than one power device. For example, each of the power switches 122 and 124 includes four MOSFETs coupled in parallel. In some embodiments, each of the power switches 112, 114, 116, 118, 122, and 124 is integrated into a power integrated circuit (IC). In some embodiments, one or more of the power switches 112, 114, 116, 118, 122, and 124 may further include a driving circuit (not shown in FIG. 1A), and the driving circuit and the corresponding power device are co-packaged into an IC.

In alternative embodiments, the converter circuit is a non-isolated LLC resonant converter. FIG. 1B is a schematic diagram of a converter circuit 100B in accordance with another embodiment of the present disclosure. As shown in FIG. 1B, the primary side circuit 110 and the secondary side circuit 120 are connected through nodes N1 and N2.

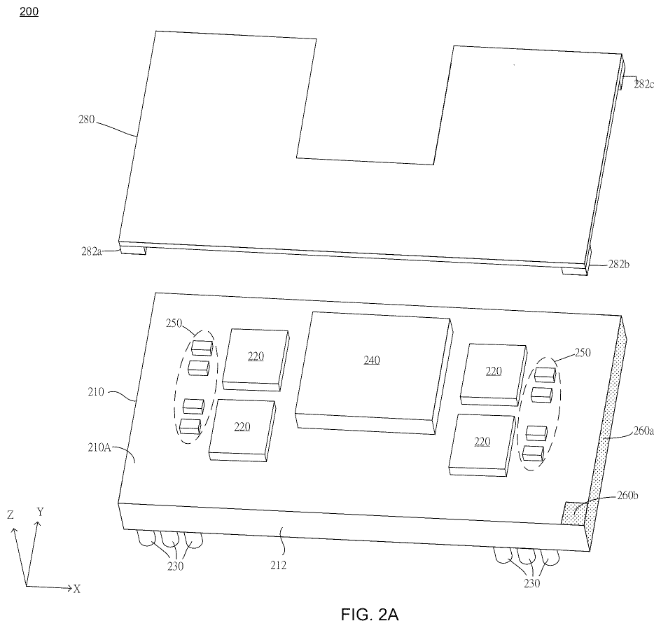

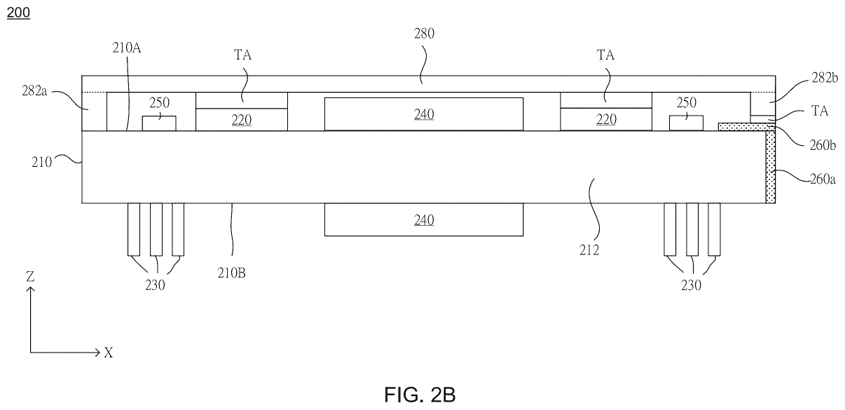

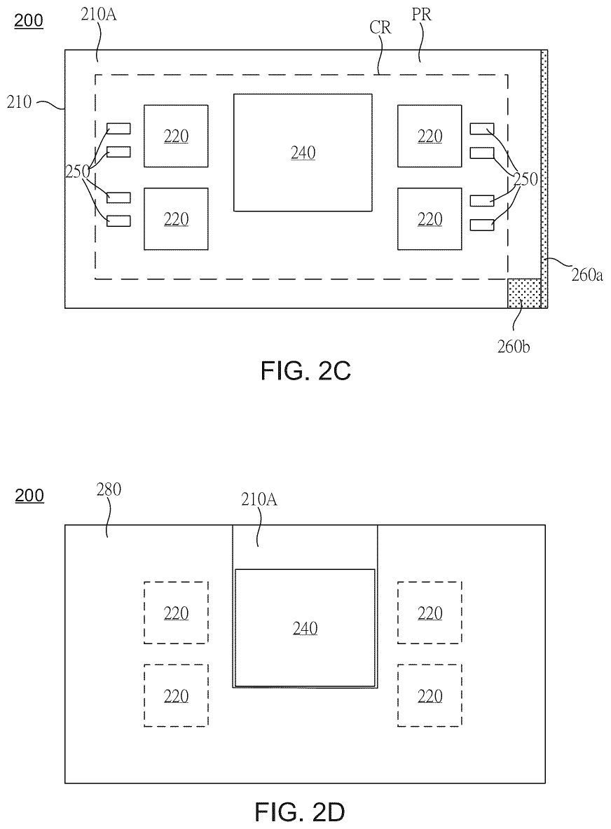

Please refer to FIG. 2A. FIG. 2A is an explosive view of a power module 200 in accordance with an embodiment of the present invention. The power module 200 includes a substrate 210, power devices 220, a magnetic component 240, and a metallic coating 260. The metallic coating 260 includes a first portion 260a and a second portion 260b. The substrate 210 has a top surface 210A, a bottom surface, and side edge surfaces 212. In the embodiment of FIG. 2A, the substrate 210 is a cuboid and has four side edge surfaces 212. In alternative embodiments, the substrate may have a shape different from a cuboid and has various numbers of side edge surfaces. The power devices 220 are disposed on the top surface 210A of the substrate 210. The magnetic component 240 is disposed on the substrate 210. In some embodiments, the magnetic component 240 includes a magnetic core, a primary winding, and a secondary winding (not shown in FIG. 2A), and the primary winding and the secondary winding are wound on the magnetic core.

As shown in FIG. 2A, the first portion 260a of the metallic coating 260 is covered on one of the side edge surfaces 212 of the substrate 210, and the second portion 260b is covered on a portion of the top surface 210A of the substrate 210. The second portion 260b is connected to the first portion 260a.

In some embodiments, the power module 200 further include a heat spreader 280. The heat spreader 280 has supporting terminals 282 that are configured to be disposed on the top surface 210A of the substrate 210. The supporting terminals 282 include supporting terminals 282a-282c.

In some embodiments, the power module 200 further includes passive components 250 and connectors 230 disposed on the substrate 210. For example, the passive components 250 are disposed on the top surface 210A, and the connectors 230 are disposed on the bottom surface. In some embodiments, the passive components 250 may be capacitors, resistors, diodes, and/or inductors. In some embodiments, each of the connectors 230 is configured to mount the power module 200 on a mother board (not shown in FIG. 2A) and transmit electrical signals between the substrate 210 and the mother board.

Please refer to FIGS. 2A and 2B. FIG. 2B is a side view of the power module 200 as shown in FIG. 2A in accordance with an embodiment of the present disclosure. As shown in FIG. 2B, the substrate 210 has the top surface 210A, the bottom surface 210B, and the side edge surface 212, and the side edge surface 212 extends between the top surface 210A and the bottom surface 210B. The metallic coating 260 is covered on the substrate 210. Specifically, the first portion 260a of the metallic coating 260 is covered on the side edge surface 212, and the second portion 260b of the metallic coating 260 is covered on a portion of the top surface 210A. The second portion 260b is connected to the first portion 260a. The heat spreader 280 is disposed on top of the power devices 220 and has the supporting terminals 282a and 282b. The supporting terminal 282a is connected to the top surface 210A, and the supporting terminal 282b is connected to the metallic coating 260. In one embodiment, as shown in FIG. 2B, the supporting terminal 282b is disposed on and connected to the second portion 260b of the metallic coating 260. In some embodiments, as shown in FIG. 2B, the supporting terminal 282b is connected to the second portion 260b through a thermal conductive adhesive TA, and the heat spreader 280 is connected to the power devices 220 through the thermal conductive adhesive TA as well.

Please refer to FIGS. 2A-2C. FIG. 2C is a top view of the power module 200 as shown in FIG. 2A in accordance with an embodiment of the present invention. In some embodiments, the top surface 210A of the substrate 210 may be divided into a center region CR and a peripheral region PR. The center region CR is surrounded by the peripheral region PR. In one embodiment, the electrical components (e.g., the magnetic component 240) and the power devices 220 are located on the center region CR, and the second portion 260b of the metallic coating 260 is located on the peripheral region PR.

As shown in FIG. 2C, the first portion 260a covered on the side edge surface is located corresponding to the second portion 260b and is connected to the second portion 260b. For clarity, FIG. 2C is not drawn to scale. In actual applications, the first portion 260a is a portion of the metallic coating and may be too thin to be identified from the top view of the power module 200.

Please refer to FIG. 2D. FIG. 2D is a top view of the power module 200 as shown in FIG. 2A with the heat spreader 280 in accordance with an embodiment of the present invention. For the convenience of illustration, in FIG. 2A, the heat spreader 280 is not disposed on the substrate 210 or the components. In actual applications, as shown in FIG. 2D, the heat spreader 280 is disposed on top of the power devices 220.

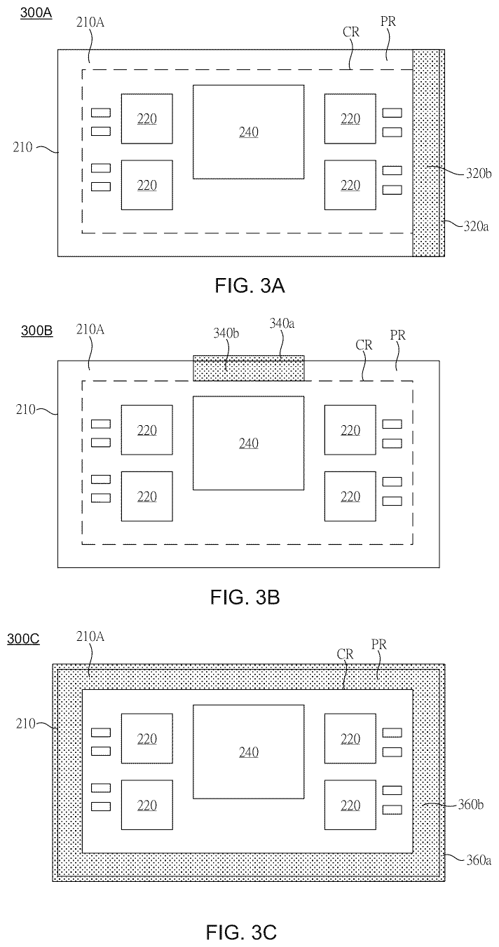

In some embodiments, the second portion of the metallic coating may be located on various portions of the peripheral region PR of the top surface 210A. Please refer to FIG. 3A. FIG. 3A is a top view of a power module 300A in accordance with another embodiment of the present invention. The power module 300A includes a metallic coating 320. The metallic coating 320 includes a first portion 320a and a second portion 320b, and the first portion 320a is covered on the side edge surface of the substrate 210. The second portion 320b is covered on a portion of the peripheral region PR that is adjacent to the first portion 320a. The second portion 320b is connected to the first portion 320a.

FIG. 3B is a top view of a power module 300B in accordance with yet another embodiment of the present invention. The power module 300B includes a metallic coating 340. The metallic coating 340 includes a first portion 340a and a second portion 340b, and the first portion 340a is covered on a portion of the side edge surface of the substrate 210. The second portion 340b is covered on a segment of the peripheral region PR. The segment of the peripheral region PR is adjacent to the first portion 340a and is adjacent to the magnetic component 240 located in the center region CR. The second portion 340b is connected to the first portion 340a.

FIG. 3C is a top view of a power module 300C in accordance with yet another embodiment of the present invention. The power module 300C includes a metallic coating 360. The metallic coating 360 includes a first portion 360a and a second portion 360b, and the first portion 360a is covered on the four side edge surfaces of the substrate 210. The second portion 360b is covered on most of the peripheral region PR of the top surface 210A and is connected to the first portion 360a covered on the side edge surfaces.

For the convenience of illustration, in FIGS. 3A-3C, the first portions 320a, 340a, and 360a covered on the side edge surface are drawn to illustrate that they are located corresponding to the second portions 320b, 340b, and 360b respectively. For clarity, FIGS. 3A-3C are not drawn to scale. In actual applications, each of the first portions 320a, 340a, and 360a is a coating and may be too thin to be identified from the top view of the power module.

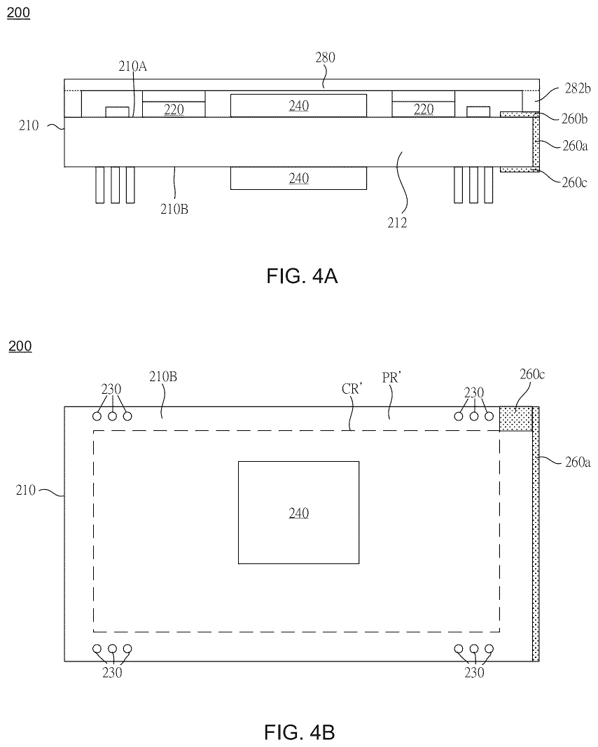

In some embodiments, the metallic coating 260 of the power module 200 as shown in FIGS. 2A-2D further includes a third portion that is located on a peripheral region of the bottom surface 210B. Please refer to FIG. 4A. FIG. 4A is a side view of the power module 200 in accordance with another embodiment of the present disclosure. Compared with FIG. 2B, as shown in FIG. 4A, the metallic coating 260 further includes a third portion 260c. The third portion 260c is covered on a portion of the bottom surface 210B and is connected to the first portion 260a covered on the side edge surface 212, which is further connected to the second portion 260b covered on the top surface 210A.

Please refer to FIG. 4B. FIG. 4B is a bottom view of the power module 200 in accordance with another embodiment of the present disclosure. In some embodiments, the third portion 260c is located on a peripheral region PR′ of the bottom surface 210B, and the electrical components (e.g., the magnetic component 240) are located on a center region CR′ surrounded by the peripheral region PR′ of the bottom surface 210B. For clarity, FIG. 4B is not drawn to scale. In actual applications, the first portion 260a is a coating and may be too thin to be identified from the top view of the power module.

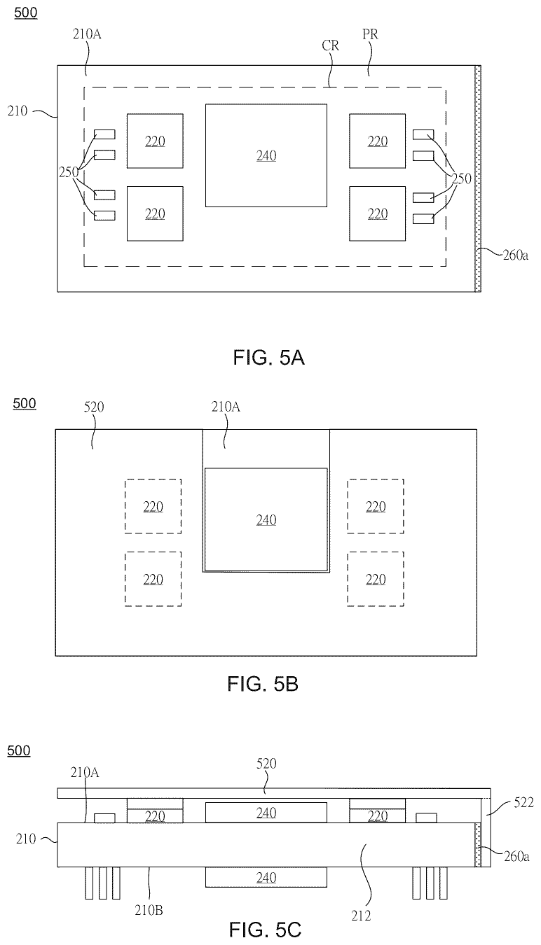

In some embodiments, the metallic coating only covers the side edge surface(s) of the substrate and does not cover the top surface of the substrate. Please refer to FIGS. 5A-5C. FIG. 5A is a top view of a power module 500 in accordance with another embodiment of the present invention. FIG. 5B is a top view of the power module 500 as shown in FIG. 5A with a heat spreader 520 in accordance with another embodiment of the present invention. FIG. 5C is a side view of the power module 500 with the heat spreader 520 in accordance with another embodiment of the present disclosure. As shown in FIG. 50, the metallic coating 260 includes the first portion 260a covered on the side edge surface 212. The heat spreader 520 is disposed on top of the power devices 220. The heat spreader 520 has a portion 522 that is connected to the first portion 260a of the metallic coating 260. Persons having ordinary skills in the art should understand that the heat spreader may have different structure to connect to the metallic coating 260 covered on the side edge surface 212.

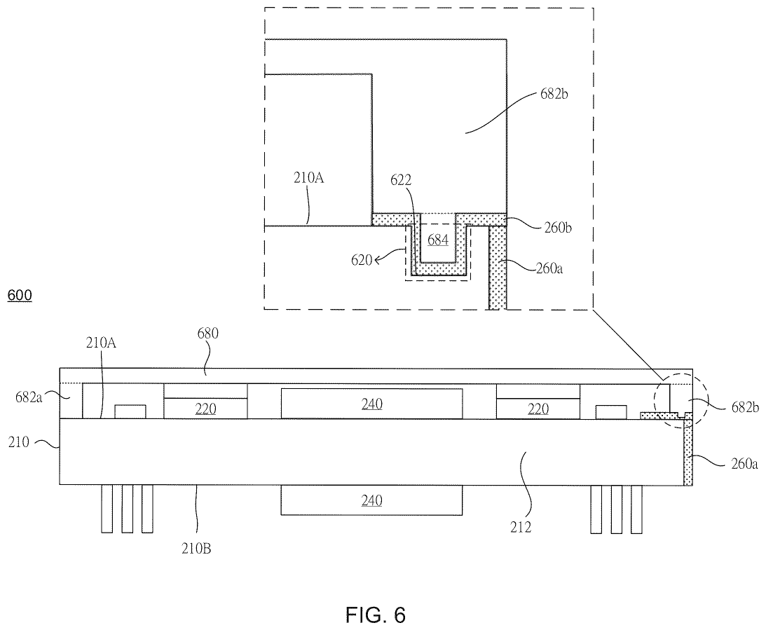

In the embodiment of FIG. 2B, the surface of the supporting terminals 282b of the heat spreader 280 that is connected to the second portion 260b is a flat surface. In alternative embodiments, the supporting terminals of the heat spreader may have different shape to connect to the second portions 260b. Please refer to FIG. 6. FIG. 6 is an enlarged view of a portion of a power module 600 in accordance with another embodiment of the present disclosure. The power module 600 includes a heat spreader 680, and the heat spreader 680 has supporting terminals 682a and 682b. As shown in the enlarged view of the supporting terminal 682b in FIG. 6, the top surface 210A of the substrate 210 includes a hole 620, and the second portion 260b of the metallic coating 260 is covered on a top surface 622 of the hole 620. The supporting terminal 682b of the heat spreader 680 includes an insertion portion 684, and the insertion portion 684 is inside the hole 620 and is in contact with the second portion 260b of the metallic coating 260. In other words, the supporting terminal 682b is configured to be inserted in the hole 620 and is in contact with the second portion 260b of the metallic coating 260.

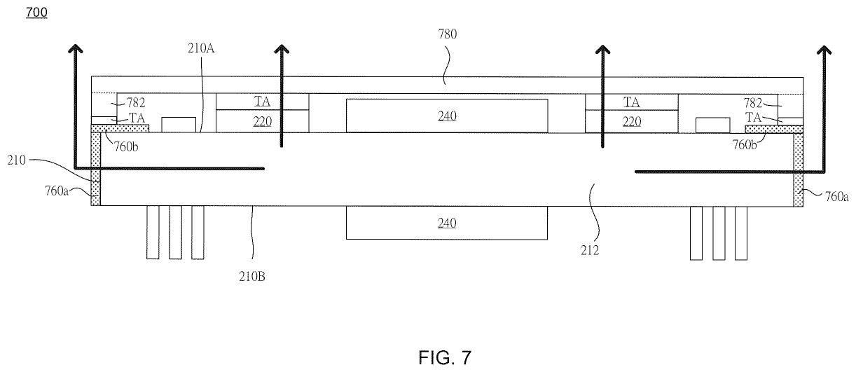

Please refer to FIG. 7. FIG. 7 is a schematic view of heat transmission paths of a power module 700 in accordance with an embodiment of the present disclosure. Arrows shown in FIG. 7 represent the directions of the heat transmission path. As shown in FIG. 7, the power module 700 includes a metallic coating 760, the metallic coating 760 includes a first portions 760a covered on the side edge surfaces 212, and the second portions 760b covered on the top surface 210A. A heat spreader 780 is disposed on top of the power devices 220 through the thermal conductive adhesive TA. The heat spreader 780 has supporting terminals 782 that are disposed on the second portions 760b through the thermal conductive adhesive TA

In some embodiments, as shown in FIG. 7, the components (e.g., the power devices 220) on the substrate 210 generate heat during the operation and transmit the heat to the heat spreader 780. Since the components generate heat during operation and are in contact with the substrate 210, the temperature of the substrate 210 also rises during the operation of the power module 700. Since the heat spreader 780 is disposed on the power devices 220 through the thermal conductive adhesive TA, heat is transmitted upward from the power devices 220 to the heat spreader 780. In addition, the metallic coating 760 provides another heat transmission path. The first portions 760a of the metallic coating 760 absorb the heat from the side edge surfaces 212 and transmit the heat upward to the second portions 760b of the metallic coating 760. The second portions 760b then transmit the heat upward to the supporting terminals 782 of the heat spreader 780. Accordingly, the metallic coating 760 transmits the heat from the substrate 210 to the heat spreader 780. Due to the additional heat transmission paths, the power module with the metallic coating in the present disclosure may better dissipate heat generated by the power module. Similarly, the power modules as shown in FIGS. 2A-2D, 3A-3C, 4A-4B, 5A-5C, and 6 may have improved heat dissipation since the metallic coating covered on the substrate and connected to the heat spreader provides additional heat transmission path for the power modules.

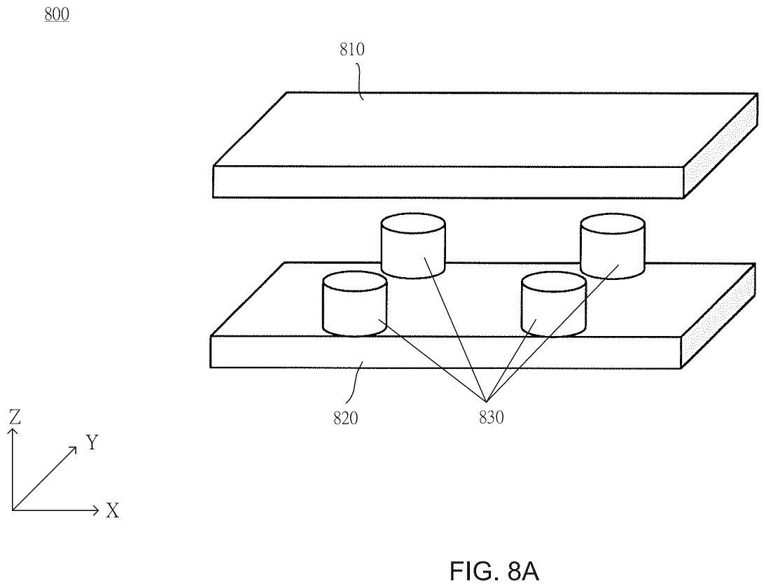

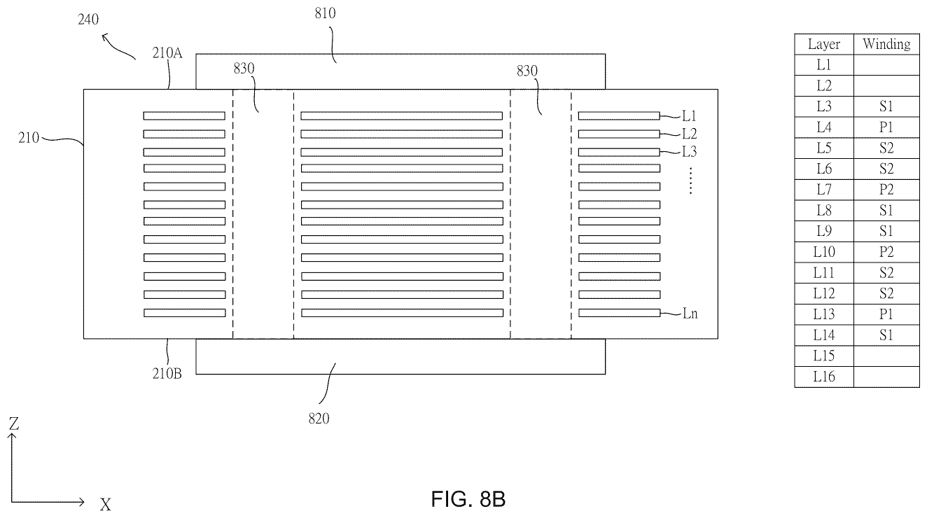

In some embodiments, the magnetic component 240 shown in FIGS. 2A-2D is a planar transformer that includes a magnetic core with four magnetic pillars. Please refer to FIG. 8A. FIG. 8A is a schematic diagram of a magnetic core 800 of the magnetic component 240 as shown in FIGS. 2A-2D in accordance with an embodiment of the present disclosure. The magnetic core 800 includes a base plate 820, a cover plate 810, and four magnetic pillars 830. The base plate 820 may be parallel or substantially parallel to the cover plate 810. The magnetic pillars 830 are connected with the base plate 820 and extend between the base plate 820 and the cover plate 810. The magnetic pillars 830 are configured to connect the base plate 820 and the cover plate 810. Persons having ordinary skills in the art should understand that the embodiment of FIG. 8A does not limit the present disclosure, and the magnetic core 800 may have a structure different from the one as shown in FIG. 8A. For example, the magnetic core 800 may have only two magnetic pillars, the magnetic pillars may be cuboid instead of cylindrical, and the cover plate 810 and the base plate 820 may be square.

Please refer to FIG. 8B. FIG. 8B is a cross-sectional view of the magnetic component 240 as shown in FIGS. 2A-2D in accordance with an embodiment of the present disclosure. As shown in FIG. 8B, the cover plate 810 of the magnetic core 800 is disposed on the top surface 210A of the substrate 210, the base plate 820 of the magnetic core 800 is disposed on the bottom surface 210B of the substrate 210, and the magnetic pillars 830 pass through the substrate 210 to connect the cover plate 810 and the base plate 820.

As shown in FIG. 8B, the substrate 210 is a multilayer PCB, each magnetic pillar 830 passes through PCB layers, and the primary winding and the secondary winding are formed on the PCB layers. In some embodiments, the primary winding is formed on a first set of the PCB layers, and the secondary winding is formed on a second set of the PCB layers. For instance, the first set includes the PCB layers L4, L7, L10, and L13, and the second set includes the PCB layers L3, L5, L6, L8, L9, L11, L12, and L14. In some embodiments, the first set of the PCB layers and the second set of the PCB layers are stacked vertically to form a winding stack.

In some embodiments, the primary winding is formed by windings P1 and P2. In one embodiment, the winding P1 is formed on the PCB layers L4 and L13, and the winding P2 is formed on the PCB layers L7 and L10. The winding P1 on the PCB layer L4 and the winding P2 on the PCB layer L7 form a first group of windings, the winding P1 on the PCB layer L13 and the winding P2 on the PCB layer L10 form a second group of windings, and the first group of windings and the second group of windings are coupled in parallel to form the primary winding. Accordingly, the primary winding is formed by the windings P1 on the PCB layers L4 and L13 and the windings P2 on the PCB layers L7 and L10. In alternative embodiments, the primary winding may include more than two groups of windings. Each group of windings includes one winding P1 and one winding P2, and the groups of windings are coupled in parallel to form the primary winding. In alternative embodiments, the primary winding may include only one group of windings.

Similarly, in some embodiments, the secondary winding is formed by windings S1 and S2. In one embodiment, one winding S1 and one winding S2 form a group of windings, and multiple groups are coupled in parallel to form the secondary winding. For example, the windings S1 and S2 are formed on the PCB layers according to the table in FIG. 8B. The winding S1 on the PCB layer L3 and the winding S2 on the PCB layer L5 form a group, the winding S2 on the PCB layer L6 and the winding S1 on the PCB layer L8 form a group, the winding S1 on the PCB layer L9 and the winding S2 on the PCB layer L11 form a group, and the winding S2 on the PCB layer L12 and the winding S1 on the PCB layer L14 form a group. These groups of windings are coupled in parallel to form the secondary winding.

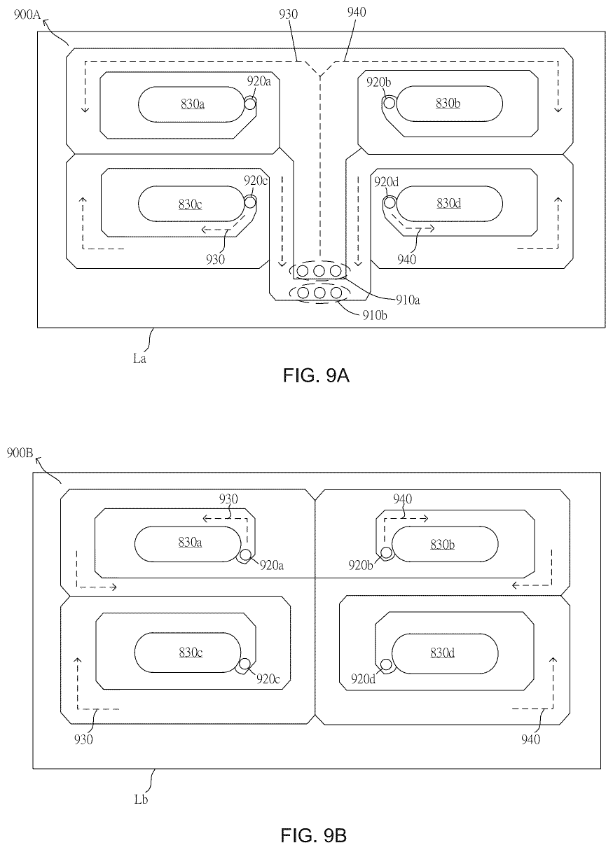

FIGS. 9A-9B are plan views of the primary windings 900A and 900B formed on the PCB layers La and Lb in accordance with an embodiment of the present disclosure. The primary winding 900A corresponds to the winding P1 in the embodiment of FIG. 8B, the primary winding 900B corresponds to the winding P2 in the embodiment of FIG. 8B, and the primary windings 900A and 900B form a group of windings. In some embodiments, two groups of windings are coupled in parallel between two terminals to form the primary winding.

In some embodiments, the PCB includes vias 910a, 910b, 920a, 920b, 920c, and 920d. The vias 910a and 910b are located on the same PCB layer La and at the same side of the primary winding 900A. The vias 910a are configured to receive a current at the first terminal of the primary windings 900A and 900B, and the vias 910b are configured to output the current at the second terminal of the primary windings 900A and 900B. In other words, the vias 910a correspond to the first terminal of the primary windings 900A and 900B, and the vias 910b correspond to the second terminal of the primary windings 900A and 900B. In one embodiment, a pair of the primary windings 900A and 900B form a group of windings, another pair of the primary windings 900A and 900B form another group of windings, and the two groups of windings are coupled in parallel between the first terminal corresponding to the vias 910a and the second terminal corresponding to the vias 910b.

Specifically, as denoted by arrows shown in FIGS. 9A-9B, starting from the vias 910a, the traces of the primary winding 900A are divided into two current paths 930 and 940. The trace of the path 930 wraps around the magnetic pillar 830a for two turns and is connected to the trace on the layer Lb through the via 920a. On the layer Lb, the trace wraps around the magnetic pillar 830a for two turns and then extends to another portion of the layer Lb. The trace then wraps around the magnetic pillar 830c for two turns and is connected back to the trace on the layer La through the via 920c. On the layer La, the trace wraps around the magnetic pillar 830c for two turns and is connected to the vias 910b. Since the traces of the current paths 930 and 940 are symmetrical, details of the current path 940 can be referred to the above description for the current path 930. In some embodiments, the lengths of the current paths 930 and 940 are substantially the same.

Accordingly, in the embodiment of FIGS. 9A and 9B, the first terminal (i.e., the vias 910a) and the second terminal (i.e., the vias 910b) of the primary windings 900A and 900B are located on the same PCB layer La and at the same side. For each of the PCB layers La and Lb, the traces of the primary windings 900A and 900B are divided into two current paths 930 and 940, and the lengths of the current paths 930 and 940 are substantially the same. Due to the current paths 930 and 940 with the same length, the current may be evenly distributed in the primary windings 900A and 900B, and the magnetic flux flowing through the magnetic pillars 830a-830d may be evenly distributed as well.

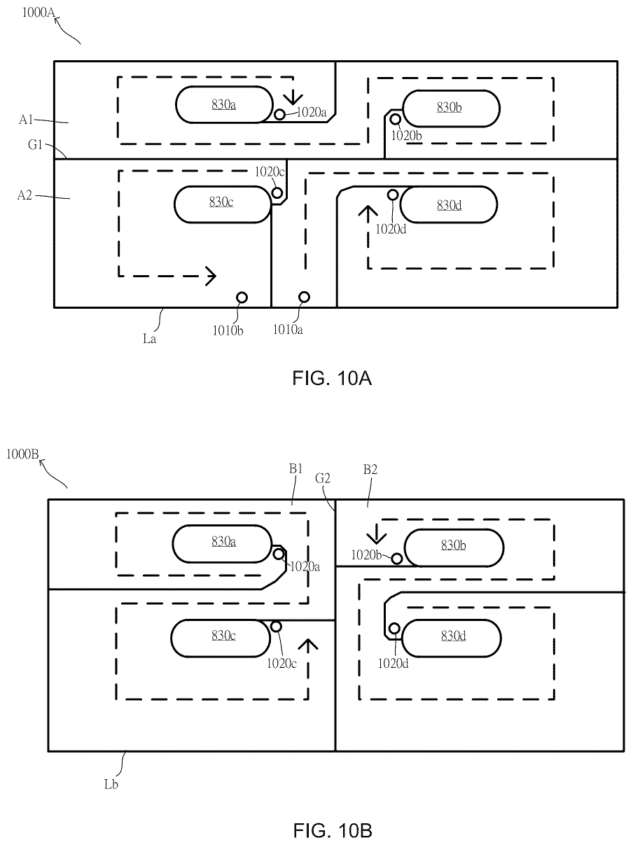

FIGS. 10A-10B are plan views of the primary windings 1000A and 1000B formed on the PCB layers La and Lb in accordance with another embodiment of the present disclosure. The primary winding 1000A corresponds to the winding P1 in the embodiment of FIG. 8B, the primary winding 1000B corresponds to the winding P2, and the primary windings 1000A and 1000B form a group of windings. In some embodiments, two groups of windings are coupled in parallel between two terminals.

In some embodiments, the PCB includes vias 1010a, 1010b, 1020a, 1020b, 1020c, and 1020d. The vias 1010a and 1010b are located on the same PCB layer La and at the same side of the primary winding 1000A. The via 1010a corresponds to the first terminal of the primary windings 1000A and 1000B, and the via 1010b corresponds to the second terminal of the primary windings 1000A and 1000B. Each of the vias 1020a, 1020b, 1020c, and 1020d is configured to transmit a current between the primary windings 1000A and 1000B in different PCB layers.

As shown in FIGS. 10A and 10B, for each of the magnetic pillars 830a-830d, the traces of the primary windings 1000A and 1000B are wound spirally on the PCB layers La and Lb. On each of the PCB layers La and Lb, the winding pattern is divided into two areas by a gap. For example, on the PCB layer La, the winding pattern of the primary winding 1000A is divided into two areas A1 and A2 by a gap G1 extending in a horizontal direction, and on the PCB layer Lb, the winding pattern of the primary winding 1000B is divided into two areas B1 and B2 by a gap G2 extending in a vertical direction.

On the PCB layer La, each of the areas A1 and A2 has two spiral patterns that are adjacent to each other horizontally. Each of the spiral patterns in the areas A1 and A2 has a circular central area that is configured to accommodate one of the magnetic pillars 830a-830d. For example, one of the spiral pattern in the areas A1 accommodates the magnetic pillar 830a, another one of the spiral pattern in the areas A1 accommodates the magnetic pillar 830b, one of the spiral pattern in the areas A2 accommodates the magnetic pillar 830c, and another one of the spiral pattern in the areas A2 accommodates the magnetic pillar 830d. Similarly, on the PCB layer Lb, each of the areas B1 and B2 has two spiral patterns that are adjacent to each other vertically. Each of the spiral patterns in the areas B1 and B2 has a circular central area that is configured to accommodate one of the magnetic pillars 830a-830d.

In one embodiment, as denoted by arrows shown in FIGS. 10A-10B, starting from the via 1010a, the trace on the layer La wraps around the magnetic pillar 830d and is connected to the trace on the layer Lb through the via 1020d. On the layer Lb, the trace wraps around the magnetic pillar 830d and extends to another portion of the layer Lb. The trace then wraps around the magnetic pillar 830b and is connected back to the trace on the layer La through the via 1020b. On the layer La, the trace wraps around the magnetic pillar 830b and extends to another portion of the layer La. The trace then wraps around the magnetic pillar 830a and is connected to the trace on the layer Lb through the via 1020a. On the layer Lb, the trace wraps around the magnetic pillar 830a and extends to another portion of the layer Lb. The trace then wraps around the magnetic pillar 830c and is connected back to the trace on the layer La through the via 1020c. On the layer La, the trace wraps around the magnetic pillar 830c and is connected to the via 1010b.

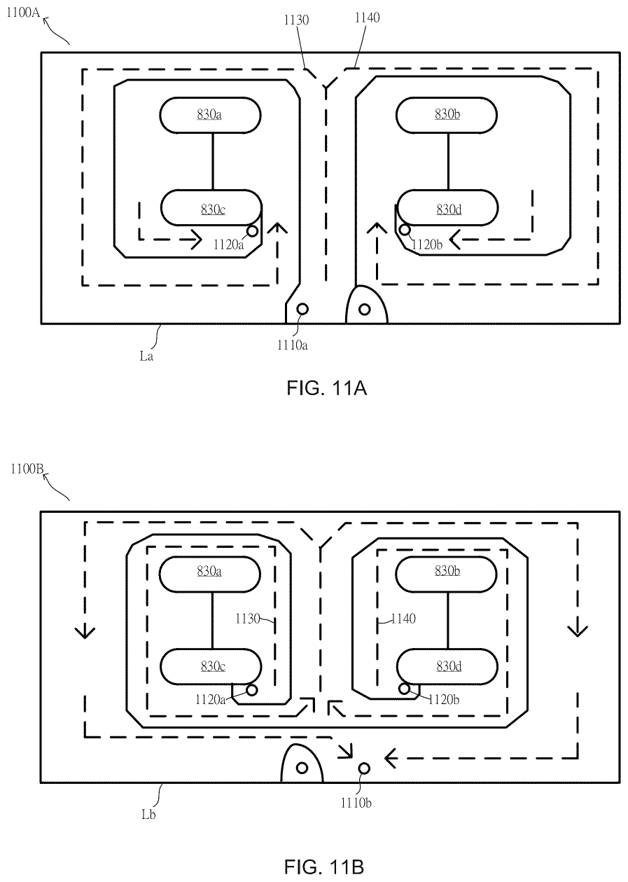

FIGS. 11A-11B are plan views of the primary windings 1100A and 1100B formed on the PCB layers La and Lb in accordance with yet another embodiment of the present disclosure. The primary winding 1100A corresponds to the winding P1 in the embodiment of FIG. 8B, the primary winding 1100B corresponds to the winding P2 in the embodiment of FIG. 8B, and the primary windings 1100A and 1100B form a group of windings. In some embodiments, two groups of windings are coupled in parallel between two terminals. In some embodiments, the PCB includes vias 1110a, 1110b, 1120a, and 1120b. The via 1110a corresponds to the first terminal of the primary windings 1100A and 1100B, and the via 1110b corresponds to the second terminal of the primary windings 1100A and 1100B.

Specifically, as denoted by arrows shown in FIGS. 11A-11B, starting from the vias 1110a, the traces of the primary winding 1100A are divided into two current paths 1130 and 1140. The trace of the path 1130 wraps around the magnetic pillar 830a and the magnetic pillar 830c as a whole for two turns and is connected to the trace on the layer Lb through the via 1120a. On the layer Lb, the trace wraps around the magnetic pillar 830a and the magnetic pillar 830c as a whole for two turns and is connected to the via 1110b. Since the traces of the current paths 1130 and 140 are symmetrical, details of the current path 1140 may be referred to the above description for the current path 1130. In some embodiments, the lengths of the current paths 1130 and 1140 are substantially the same.

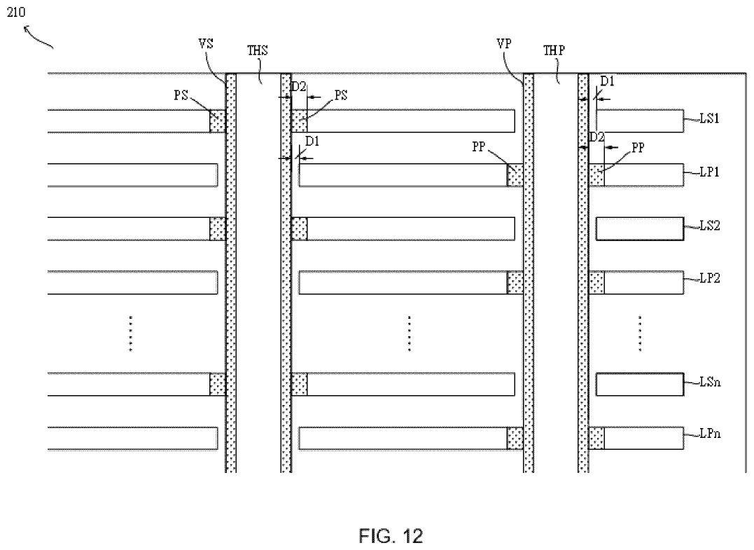

Please refer to FIG. 12. FIG. 12 is a schematic cross-sectional view of a winding stack formed in the substrate 210 in accordance with an embodiment of the present disclosure. In the embodiment of FIG. 12, only the PCB layers on which the windings are formed are shown, and other PCB layers (e.g., PCB layers formed on the top and bottom surfaces of the substrate 210 and used for electrical connections between components) are omitted in FIG. 12. For example, the primary winding is formed on PCB layers LP1-LPn, and the secondary winding is formed on PCB layers LS1-LSn. In some embodiments, the PCB layers LP1-LPn are referred to as the first set of the PCB layers, and the PCB layers LS1-LSn are referred to as the second set of the PCB layers. The PCB layers LP1-LPn and the PCB layers LS1-LSn are stacked vertically to form a winding stack in the substrate 210. The winding stack includes first vias (e.g., a first via VP) and second vias (e.g., a second via VS).

The first via VP is configured to electrically connect traces of the primary winding on different PCB layers (e.g., the traces formed on the PCB layers LP1 and LP2), and the second via VS is configured to electrically connect traces of the secondary winding on different PCB layers (e.g., the traces formed on the PCB layers LS1 and LS2). Specifically, for each of the PCB layers LP1-LPn, the first via VP has a through-hole THP and a pad PP surrounded the through-hole THP. The through-hole THP has a conductive wall, and the pad PP is formed on the conductive wall of the through-hole THP and extends outwardly from the center of the through-hole THP. Thus, the first via VP is electrically connected to the traces on each of the PCB layers of the primary winding (e.g., formed on the PCB layers LP1-LPn) through the pad PP. In some embodiments, the pad PP extends between the conductive wall of the through-hole THP and each of the PCB layers LP1-LPn and has a width D2. It is worth noted that, for each of the PCB layers LS1-LSn, the first via VP does not have the pad since the primary winding does not connect to the secondary winding formed on PCB layers LS1-LSn. Since there is no need to for the PCB layers LS1-LSn to be connected to the first via VP, the pad of the first via VP could be removed, and the traces on each of the PCB layers LS1-LSn may extend closer toward the first via VP. For example, as shown in FIG. 12, without the pad PP, the traces on each of the PCB layers LS1-LSn are isolated from the conductive wall of the through-hole THP by a distance D1, and the distance D1 is smaller than the width D2 of the pad PP. Accordingly, compared with the traces on the PCB layers LP1-LPn, the traces on the PCB layers LS1-LSn with smaller distance to the first via VP have larger areas for the current to flow through, and the transmission loss is reduced.

Similarly, for each of the PCB layers LS1-LSn, the second via VS has a through-hole THS and a second pad PS surrounded the through-hole THS. The through-hole THS has a conductive wall, and the pad PS is formed on the conductive wall of the through-hole THS and extends outwardly from the center of the through-hole THS. Thus, the second via VS is electrically connected to the traces on each of the PCB layers of the secondary winding (e.g., formed on the PCB layers LS1-LSn) through the pad PS. Since there is no need for the PCB layers LP1-LPn to be connected to the second via VS, the pad of the second via VS could be removed, and the traces on each of the PCB layers LP1-LPn may extend closer toward the conductive wall of the through-hole THS. Therefore, the traces on the PCB layers LP1-LPn with smaller distance to the second via VS have larger areas for the current to flow through, and the transmission loss is reduced.

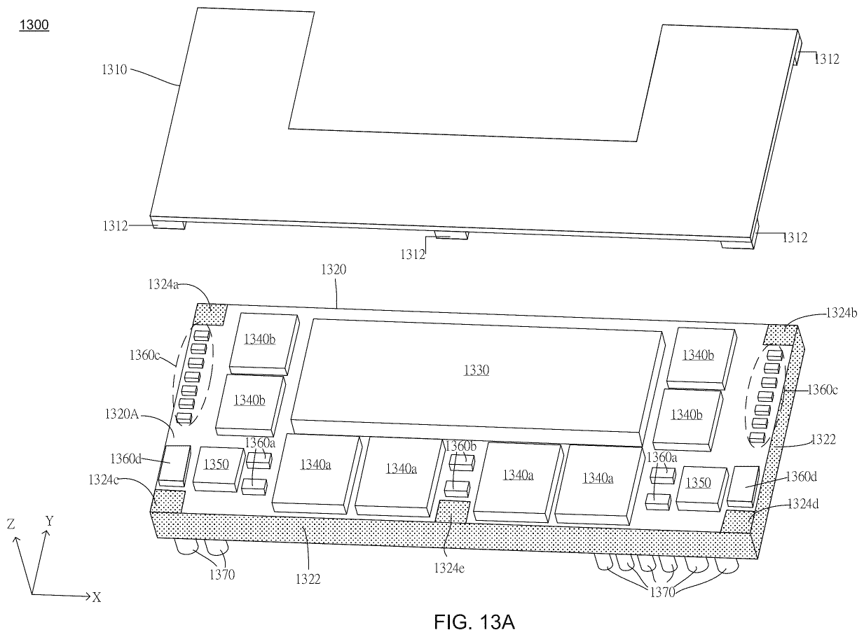

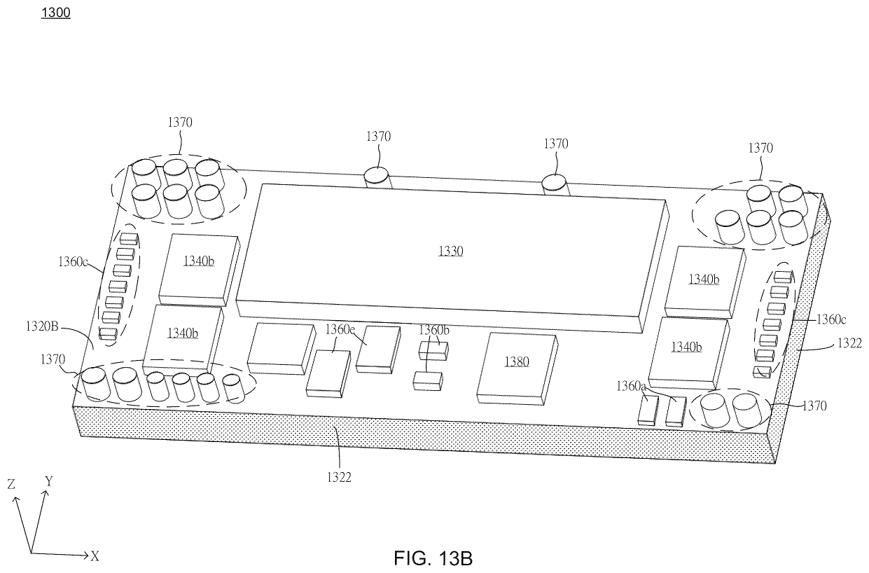

FIG. 13A is an explosive view of a power module 1300 in accordance with an embodiment of the present invention. FIG. 13B is a bottom view of the power module 1300 in accordance with an embodiment of the present disclosure. In one embodiment, the power module 1300 includes a DC-DC converter circuit 100A as shown in FIG. 1A, with the power devices 1340a being the primary-side power switches 112, 114, 116, and 118, the power devices 1340b being the secondary-side power switches 122 and 124. In another embodiment, the power module 1300 includes a DC-DC converter circuit 100B as shown in FIG. 1B, with the power devices 1340a being the primary-side power switches 112, 114, 116, and 118, the power devices 1340b being the secondary-side power switches 122 and 124.

As shown in FIGS. 13A-13B, the power module 1300 includes a substrate 1320, multiple power devices 1340, and a magnetic component 1330. The power devices 1340 include power devices 1340a and power devices 1340b. The substrate 1320 has a top surface 1320A, a bottom surface 1320B, and side edge surfaces. In the embodiment of FIGS. 13A-13B, the substrate 1320 has four side edge surfaces. In some embodiments, at least part of the power devices 1340a and 1340b are disposed on the top surface 1320A of the substrate 1320. For example, as shown in FIGS. 13A-13B, the power devices 1340a are disposed on the top surface 1320A, and the power devices 1340b are disposed on both the top surface 1320A and the bottom surface 1320B. The magnetic component 1330 is disposed on the substrate 1320.

In some embodiments, the power devices 1340a and 1340b may include power switches, e.g., MOSFETs. In some embodiments, each of the power devices 1340a and 1340b are an IC. In some embodiments, the power module 1300 further includes multiple driver ICs 1350 disposed on the top surface 1320A of the substrate 1320, and the driver ICs 1350 are configured to provide driving signals to at least one of the power devices 1340a and 1340b. In alternative embodiments, a driver circuit and a power switch are integrated into an IC (for example, integrated in the power devices 1340a and 1340b).

In some embodiments, the magnetic component 1330 is a transformer having a magnetic core, a primary winding, and a secondary winding. In some embodiments, the magnetic component 1330 is a planar transformer and has a structure as shown in FIG. 8B.

In some embodiments, the power module 1300 may further include a controller 1380 configured to control the power devices 1340a and 1340b. In one embodiment, as shown in FIG. 13B, the controller 1380 is disposed on the bottom surface 1320B of the substrate 1320. In some embodiments, the power module 1300 may further include passive components 1360 disposed on the top surface 1320A and the bottom surface 1320B of the substrate 1320. In one embodiment, as shown in FIGS. 13A-13B, the passive components 1360 includes passive components 1360a, 1360b, 1360c, 1360d, and 1360e. In some embodiments, the passive components 1360 may be capacitors, resistors, diodes, and/or inductors. In one implementation, the passive components 1360a are input capacitors. In one implementation, the passive components 1360b are resonant capacitors. In one implementation, the passive components 1360c are output capacitors. In one implementation, the passive components 1360d are diodes. In one implementation, and the passive components 1360e are inductors. In some embodiments, the power module 1300 may further include at least a connector 1370 disposed on the bottom surface 1320B of the substrate 1320.

In some embodiments, as shown in FIG. 13A, the power module 1300 further includes a heat spreader 1310 disposed on top of the power devices 1340a and 1340b. The heat spreader 1310 has supporting terminals 1312 connected to the top surface 1320A of the substrate 1320. In some embodiments, the heat spreader 1310 provides a flat topmost surface for installing an external heat sink on the heat spreader 1310. In some embodiments, the heat spreader 1310 is made by metal (e.g., aluminum or copper).

In some embodiments, the power module 1300 further includes a metallic coating that is covered on the substrate 1320. The metallic coating includes first portions 1322 covered on the side edge surfaces of the substrate 1320 and second portions 1324 covered on portions of the top surface 1320A of the substrate 1320. The second portions 1324 include second portions 1324a-1324e. In some embodiments, the second portions 1324 of the metallic coating are located on a peripheral region of the top surface 1320A, and electrical components (e.g., the driver ICs 1350) and the power devices 1340a and 1340b are located on a center region that is surrounded by the peripheral region of the top surface 1320A. The first portions 1322 are connected to the second portions 1324, and the second portions 1324 are connected to the heat spreader 1310 through the supporting terminals 1312. The first portions 1322 of the metallic coating are configured to absorb heat through the side edge surfaces of the substrate 1320 and transmit the heat to the second portions 1324 of the metallic coating. In some embodiments, at least one of the supporting terminals 1312 of the heat spreader 1310 is connected to the metallic coating. In one embodiment, at least one of the supporting terminals 1312 is connected to the second portion 1324 of the metallic coating. Accordingly, the metallic coating can receive heat from the side edge surfaces of the substrate 1320 and then transmit the heat to the heat spreader 1310 through the supporting terminals 1312 of the heat spreader 1310.

In one embodiment, as shown in FIGS. 13A-13B, the first portions 1322 extend along and cover the four side edge surfaces of the substrate 1320. In alternative embodiment, the first portion 1322 extends along and covers only one of the side edge surfaces. In the embodiment of FIG. 13A, the second portions 1324a, 1324b, 1324c, 1324d are disposed on the four corners of the top surface 1320A of the substrate 1320, the second portion 1324e is disposed between two of the power devices 1340a and adjacent to the passive components 1360b, and the supporting terminals 1312 of the heat spreader 1310 are located corresponding to the locations of the second portions 1324a-1324e. In some embodiments, the metallic coating may include more second portions located on the peripheral region as shown in FIGS. 3A-3C, and the heat spreader 1310 may include more supporting terminals that connect these second portions of the metallic coating to the heat spreader 1310.

The present disclosure provides a power module with metallic coating covered on the side edge surface and the top surface of the substrate. Since the metallic coating is connected to the heat spreader, heat may be transmitted from the substrate to the heat spreader through the metallic coating. In addition, the power module includes a planar transformer. Due to the traces and the winding pattern on the PCB winding layers, currents may be evenly distributed in the winding. Moreover, since the vias in the winding stack do not have pads on some of the PCB layers, the traces in the PCB layers may have more area for the current to flow through, and the winding loss may be reduced.

While various embodiments have been described above to illustrate the switch circuit of the present disclosure, it should be understood that they have been presented by way of example only, and not limitation. Rather, the scope of the present disclosure is defined by the following claims and includes combinations and sub-combinations of the various features described above, as well as variations and modifications thereof, which would occur to persons skilled in the art upon reading the foregoing description.

What is claimed is:

1. A power module, comprising:
a substrate having a top surface, a bottom surface, and a side edge surface, wherein the side edge surface extends between the top surface and the bottom surface;
a plurality of power devices disposed on the top surface of the substrate;
a magnetic component disposed on the substrate, wherein the magnetic component includes a magnetic core, a primary winding, and a secondary winding, and the primary winding and the secondary winding are wound on the magnetic core;
a metallic coating covered on the substrate, wherein the metallic coating includes a first portion and a second portion, the first portion is covered on the side edge surface of the substrate, and the second portion is covered on a portion of the top surface of the substrate, and the second portion is connected to the first portion; and
a heat spreader disposed on top of the plurality of power devices, wherein the heat spreader has at least one supporting terminal connected to the top surface of the substrate, and one of the at least one supporting terminals is connected to the metallic coating.

2. The power module of claim 1, wherein the second portion of the metallic coating is located on a peripheral region of the top surface, and a plurality of electrical components and the power devices are located on a center region surrounded by the peripheral region of the top surface.

3. The power module of claim 1, wherein the at least one of the plurality of supporting terminals is connected to the second portion of the metallic coating through a thermal conductive adhesive.

4. The power module of claim 1, wherein the metallic coating further includes a third portion, the third portion is located on a peripheral region of the bottom surface, a plurality of electrical components are located on a center region surrounded by the peripheral region of the bottom surface, and the third portion is connected to the first portion.

5. The power module of claim 1, wherein the top surface of the substrate includes a hole, and the second portion of the metallic coating is covered on a top surface of the hole;
wherein the at least one of the plurality of supporting terminals is configured to be inserted in the hole, and is in contact with the second portion of the metallic coating.

6. The power module of claim 1, wherein the primary winding has a first terminal and a second terminal, the primary winding is formed on multiple PCB layers, the PCB layers are stacked vertically to form a winding stack, and the first terminal of the primary winding and the second terminal of the primary winding are located on the same PCB layer and at a same side;
wherein for each PCB layer, traces of the primary winding are divided into two current paths, and lengths of the two current paths are substantially the same.

7. The power module of claim 1, wherein the magnetic core has four magnetic pillars;
wherein the primary winding is formed on multiple PCB layers;
wherein for each of the magnetic pillars, the primary winding is wound spirally on different layers of PCB, and each PCB layer has a winding pattern that is divided into two areas by a gap extending in a first direction, each of the areas has two spiral patterns that are adjacent to each other in the first direction, and each of the spiral patterns has a circular central area that is configured to accommodate one of the magnetic pillars of the magnetic core.

8. The power module of claim 1,
wherein the primary winding is formed on a first set of PCB layers, the secondary winding is formed on a second set of PCB layers, the first set of PCB layers and the second set of PCB layers are stacked vertically to form a winding stack;
wherein the winding stack includes first vias and second vias, each of the first vias is configured to electrically connect traces of the primary winding on different PCB layers, and each of the second vias is configured to electrically connect traces of the secondary winding on different PCB layers;
wherein for each of the first set of PCB layers, each of the first vias has a first through-hole and a first pad surrounded the first through-hole, and for each of the second set of PCB layers, each of the second vias has a second through-hole and a second pad surrounded the second through-hole.

9. A power module, comprising:
a substrate having a top surface, a bottom surface, and a side edge surface, wherein the side edge surface extends between the top surface and the bottom surface;
a plurality of power devices disposed on the top surface of the substrate; and
a magnetic component disposed on the substrate, wherein the magnetic component includes a magnetic core, a primary winding, and a secondary winding, and the primary winding and the secondary winding are wound on the magnetic core;
wherein the primary winding is formed on a first set of PCB layers, the secondary winding is formed on a second set of PCB layers, the first set of PCB layers and the second set of PCB layers are stacked vertically to form a winding stack;
wherein the winding stack includes first vias and second vias, each of the first vias is configured to electrically connect traces of the primary winding on different PCB layers, and each of the second vias is configured to electrically connect traces of the secondary winding on different PCB layers;
wherein for each of the first set of PCB layers, each of the first vias has a first through-hole and a first pad surrounded the first through-hole, and for each of the second set of PCB layers, each of the second vias has a second through-hole and a second pad surrounded the second through-hole.

10. The power module of claim 9, further comprising:
a metallic coating covered on the substrate, wherein the metallic coating includes a first portion and a second portion, the first portion is covered on the side edge surface of the substrate, and the second portion is covered on a portion of the top surface of the substrate, and the second portion is connected to the first portion.

11. The power module of claim 10, further comprising:
a heat spreader disposed on top of the plurality of power devices, wherein the heat spreader has at least one supporting terminal connected to the top surface of the substrate, and one of the at least one supporting terminals is connected to the metallic coating.

12. The power module of claim 10, wherein the second portion of the metallic coating is located on a peripheral region of the top surface, and a plurality of electrical components and the power devices are located on a center region surrounded by the peripheral region of the top surface.

13. The power module of claim 10, wherein the metallic coating further includes a third portion, the third portion is located on a peripheral region of the bottom surface, a plurality of electrical components are located on a center region surrounded by the peripheral region of the bottom surface, and the third portion is connected to the first portion.

14. The power module of claim 9, wherein the primary winding has a first terminal and a second terminal, and the first terminal of the primary winding and the second terminal of the primary winding are located on the same PCB layer of the first set of PCB layers and at a same side;
wherein for each PCB layer of the first set of PCB layers, traces of the primary winding are divided into two current paths, and lengths of the two current paths are substantially the same.

15. The power module of claim 9, wherein the magnetic core has four magnetic pillars;
wherein for each of the magnetic pillars, the primary winding is wound spirally on different PCB layers of the first set of PCB layers, and each PCB layer the first set of PCB layers has a winding pattern that is divided into two areas by a gap extending in a first direction, each of the areas has two spiral patterns that are adjacent to each other in the first direction, and each of the spiral patterns has a circular central area that is configured to accommodate one of the magnetic pillars of the magnetic core.

16. A power module, comprising:
a substrate having a top surface, a bottom surface, and a side edge surface, wherein the side edge surface extends between the top surface and the bottom surface;
a plurality of power devices disposed on the top surface of the substrate;
a magnetic component disposed on the substrate, wherein the magnetic component includes a magnetic core, a primary winding, and a secondary winding, and the primary winding and the secondary winding are wound on the magnetic core;
a metallic coating covered on the side edge surface of the substrate; and
a heat spreader disposed on top of the plurality of power devices, wherein the heat spreader is connected to the metallic coating.

17. The power module of claim 16, wherein the metallic coating is further covered on a peripheral region of the top surface of the substrate, and a plurality of electrical components and the power devices are located on a center region surrounded by the peripheral region of the top surface.

18. The power module of claim 16, wherein the primary winding has a first terminal and a second terminal, the primary winding is formed on multiple PCB layers, the PCB layers are stacked vertically to form a winding stack, and the first terminal of the primary winding and the second terminal of the primary winding are located on the same PCB layer and at a same side;
wherein for each PCB layer, traces of the primary winding are divided into two current paths, and lengths of the two current paths are substantially the same.

19. The power module of claim 16, wherein the magnetic core has four magnetic pillars;
wherein the primary winding is formed on multiple PCB layers;
wherein for each of the magnetic pillars, the primary winding is wound spirally on different layers of PCB, and each PCB layer has a winding pattern that is divided into two areas by a gap extending in a first direction, each of the areas has two spiral patterns that are adjacent to each other in the first direction, and each of the spiral patterns has a circular central area that is configured to accommodate one of the magnetic pillars of the magnetic core.

20. The power module of claim 16,
wherein the primary winding is formed on a first set of PCB layers, the secondary winding is formed on a second set of PCB layers, the first set of PCB layers and the second set of PCB layers are stacked vertically to form a winding stack;
wherein the winding stack includes first vias and second vias, each of the first vias is configured to electrically connect traces of the primary winding on different PCB layers, and each of the second vias is configured to electrically connect traces of the secondary winding on different PCB layers;
wherein for each of the first set of PCB layers, each of the first vias has a first through-hole and a first pad surrounded the first through-hole, and for each of the second set of PCB layers, each of the second vias has a second through-hole and a second pad surrounded the second through-hole.
